(19) United States
(12) Patent Application Publication
(10) Pub. No.: US 2021/0294676 A1
(43) Pub. Date: Sep. 23, 2021

(54) DATA CONSUMER API FOR DATA DELIVERED VIA MESSAGE BROKER

(71) Applicant: Target Brands, Inc., Minneapolis, MN (US)

(72) Inventors: Manuel Quinones, Jordan, MN (US); Adam Keyser, Eagan, MN (US); John David Tinetti, Arvada, CO (US); Roberto Perez Alcolea, Campbell, CA (US)

(21) Appl. No.: 16/826,857

(22) Filed: Mar. 23, 2020

(51) Int. Cl. G06F 9/54; G06F 12/0864

(52) U.S. Cl. CPC G06F 9/546; G06F 12/0864; G06F 9/547

(57) ABSTRACT

A computer-implemented method includes receiving a message from a message broker that receives messages from a plurality of message producers and reading a value in the message. The read value is stored in a memory location of a memory structure stored in a memory. The memory location is identified by a pointer, wherein the pointer requires less memory space than the value. An attribute value for a programming object is stored in the memory, wherein the attribute value is set equal to the pointer.

### BACKGROUND

In message broker systems, one or more message producers send messages to a message broker which stores the messages for later consumption by one or more message consumers. Each message contains a plurality of key-value pairs. When requesting a message, a message consumer provides an index representing the next message they wish to consume. Acquiring large amounts of data from the message producers is time consuming for the message consumers and is not conducive to rapid data access.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes receiving a message from a message broker that receives messages from a plurality of message producers and reading a value in the message. The read value is stored in a memory location of a memory structure stored in a memory. The memory location is identified by a pointer, wherein the pointer requires less memory space than the value. An attribute value for a programming object is stored in the memory, wherein the attribute value is set equal to the pointer.

In accordance with a further embodiment, a method includes receiving a text file identifying a message broker and a location for an object store and generating a producer software module and a consumer software module such that the producer software module is configured to request messages from the message broker and store objects at the object store based on the requested messages and such that the consumer software module is configured to access the object store to retrieve stored objects.

In accordance with a further embodiment, a system includes a processor executing a producer module configured to request messages from a message broker, to set values for objects in a memory cache based on the messages and to designate states of the memory cache. An object store separate from the producer module and the memory cache contains a state of the memory cache. A second processor executes a consumer module configured to request a state of the memory cache from the object store and maintain the state of the memory cache in a memory cache associated with the consumer module.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system in accordance with one embodiment.

FIG. 2 is a flow diagram of the operation of a producer in accordance with one embodiment.

FIG. 3 is a flow diagram of a method of creating/modifying objects using key-value pairs in messages.

FIG. 4 is a block diagram of a system for creating and deploying producers and consumers.

FIG. 5 is an example of a text file consumed by an artifact generator.

FIG. 6 is a flow diagram of a method of generating artifacts.

FIG. 7 is a block diagram of a computing device that can be used as a server in the various embodiments.

### DETAILED DESCRIPTION

Embodiments described below provide a system that allows rapid access to data generated by message producers while using data deduplication to require less memory for the data.

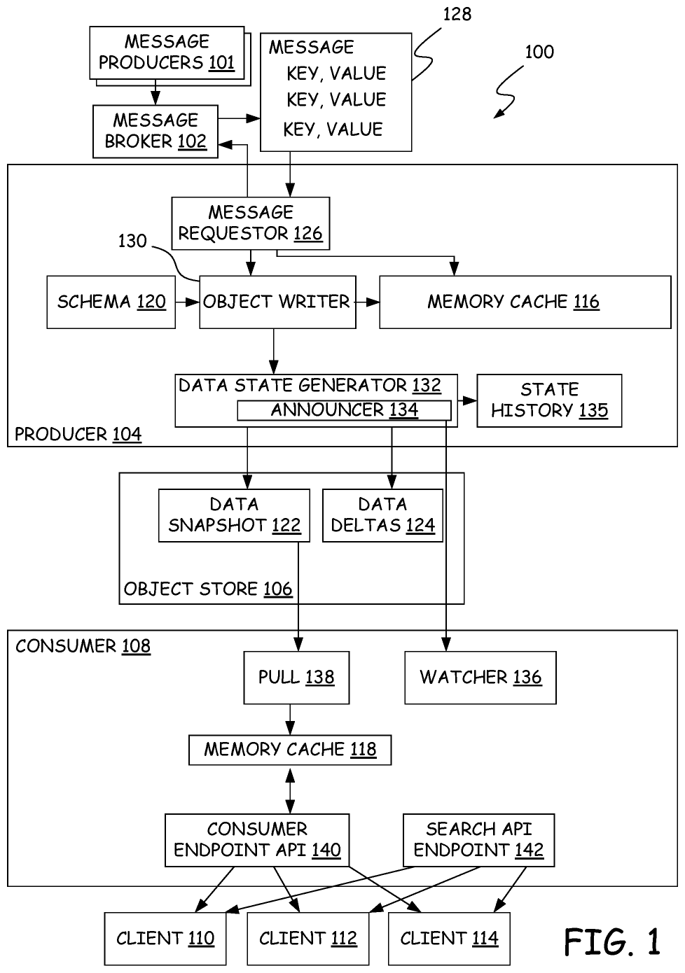

In accordance with one embodiment shown in FIG. 1, a system 100 includes a collection of message producers 101, a message broker 102, a producer 104, an object store 106, a consumer 108 and a plurality of clients 110, 112 and 114. Message producers 101 send messages to message broker 102, which holds the messages until one is requested by producer 104. Message broker 102 then sends one of the messages 128 to producer 104. Producer 104, which is a software module executed by a processor, converts the received messages into objects that are stored in a memory cache 116 within producer 104. Memory cache 116 is maintained in Random Access Memory to provide quick writing and reading of data. At intermittent times, producer 104 generates a data state containing the values set for the objects in memory cache 116 and stores that data state in an object store 106 that is separate from producer 104 and memory cache 116. Consumer 108, which is a software module executed by a second processor, retrieves the data in object store 106 and stores it in a local memory cache 118 assigned to consumer 108. Consumer 108 receives API requests for the data from clients 110, 112 and 114 and in response to those requests provides the requested data.

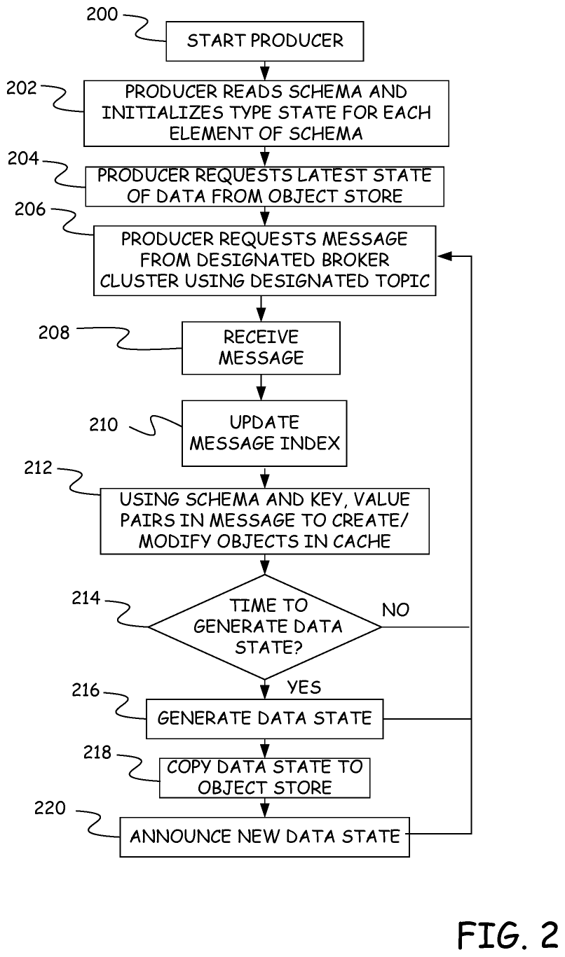

FIG. 2 provides a flow diagram of a method for converting key-value pairs stored in messages created by message producers 101 into object data stored in object store 106. In step 200 of FIG. 2, producer 104 is started on a computing device, such as a virtual machine executed by a processor. At step 202, producer 104 reads a schema 120 that contains a definition for each class of object to be stored in object store 106. Each object definition contains a name for the object class and names and data types for each attribute of the object. The data type for an attribute can be a direct data type, such as integer, or may be a reference data type that makes reference to another object or a set or list of other objects. For each object class read from the schema, producer 104 initializes a type state for the object by creating a memory structure in memory cache 116 to hold instances of the object class.

At step 204, producer 104 requests the latest state of the data from object store 106. This request is made because it is possible that the producer 104 is being restarted and must recover the data state that was previously stored in object store 106. If producer 104 was not previously running, object store 106 will empty. However, if producer 104 is being restarted, object store 106 will include a data snapshot 122 as well as zero or more data deltas 124. Data snapshot 122 represents the entire contents of memory cache 116 at a particular time, while data deltas 124 represent changes to the memory cache since the data snapshot 122 or the previous data delta. If multiple data deltas 124 are provided, each data delta 124 represents the changes in memory cache 116 since the previous data delta was generated or if there is no previous data delta, the data delta represents the changes in memory cache 116 since the previous data snapshot 122. Using data snapshot 122 and data deltas 124, producer 104 rebuilds cache 116 to include all of the object data found in object store 106 as of the time when the latest snapshot or data delta was stored in object store 106.

At step 206, producer 104 uses a message broker cluster identifier and a message topic that are stored as part of producer 104 to request a message from message broker 102. In particular, a message requestor 126 of producer 104 request the next message from message broker 102 using a message index that is stored as part of memory cache 116 and represents the last message requested and received by message requestor 126. At step 208, message requestor 126 receives a message 128 containing a plurality of key-value pairs from message broker 102.

At step 210, message requestor 126 updates cache memory 116 to indicate the latest message index received from message broker 102. By storing the message index in memory cache 116, the message index will be written to object store 106 together with the latest generated data state. As a result, if producer 104 needs to be restarted, the message index associated with the latest data state stored in object store 106 will be recovered allowing the data state to be in sync with the message index. Producer 104 can then recover the next message from message broker 102. Note that if producer 104 failed after processing one or more messages without generating a new data state, the message index stored in object store 106 will not reflect the last message processed by producer 104. However, the message index will be synchronized to the data state stored in object store 106. As a result, when producer 104 is restarted, message requestor 126 will use the message index to re-request a message that it had previously received. Producer 104 will then reprocess and restore the data from the previously received message into memory cache 116. Even though producer 104 will have to repeat the processing and storage steps, the data integrity will be maintained by keeping the index in sync with the data state.

At step 212, an object writer 130 in producer 104 uses schema 120 and key-value pairs in message 128 to create/modify objects stored in memory cache 116 while performing deduplication of the data.

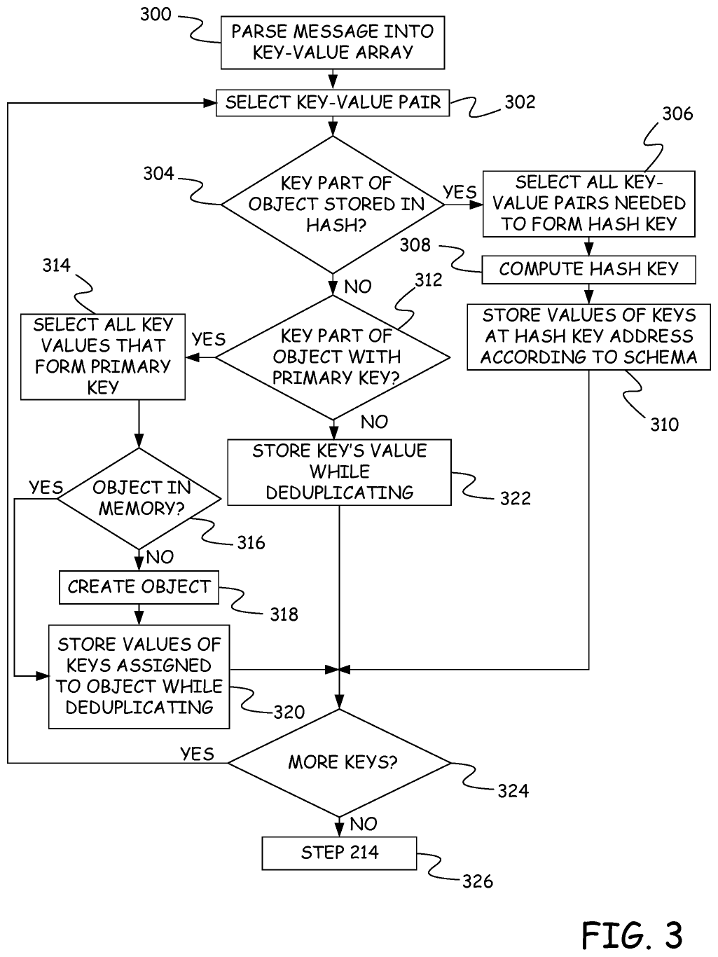

FIG. 3 provides a flow diagram of a method in accordance with one embodiment for performing step 212 of FIG. 2. In step 300, object writer 130 parses message 128 to place the key-value pairs into an array. At step 302, one of the key-value pairs is selected and at step 304, schema 120 is examined to determine if the selected key is part of an object stored in a memory structure addressed by a hash key. If the key is stored in a memory structure addressed by a hash key, all key-value pairs needed to form the hash key are selected at step 306. At step 308, the hash key is computed using the selected values. The values to be stored at the address designated by the hash key are then identified from schema 120 and are stored at the memory location identified by the hash key at step 310.

If the key selected at step 302 is not part of an object addressed by a hash key at step 304, schema 120 is consulted to determine if the key is part of an object that has a primary key. If the selected key is part an object that has a primary key at step 312, schema 120 is consulted to determine all of the keys that are needed to form the primary key at step 314. The corresponding values in the key-value array are then used to form the primary key and a search of memory cache 116 is performed to determine if an object with the primary key already exists in memory cache 116 at step 316. If an object having that primary key has not been created, the object is created at step 318. If the object already existed in memory cache 116 or after the object is created at step 318, the values of keys assigned to the object are set as attribute values for the object in memory cache 116 while performing deduplicating at step 320.

Deduplication is achieved by using pointers to stored values in place of actual values such that multiple objects can point to the same stored value instead of each object storing a separate copy of the value. Schema 120 is used to designate which object attributes are to receive actual values and which object attributes are to receive pointers. In particular, object attributes that are to receive values have their data type set to the data type of the value they are to receive such as Integer. Object attributes that are to receive pointers have their data type set to a reference type that refers to another object in schema 120.

When a value for an object attribute is to be stored, object writer first determines if the object attribute has a reference data type. If the object attribute does not have a reference data type, the value is written into the object's memory structure. If the object attribute does have a reference data type, object writer 130 accesses the memory structure of the reference data type. This reference data memory structure is then searched to see if the value to be stored for the object attribute is already in the reference data memory structure. If the value has already been stored in the reference data memory structure, a pointer for the location of the value in the reference data memory structure is retrieved and is stored as the value for the object attribute. If the value has not been previously stored in the reference data memory structure, the value is stored in the reference data memory structure and the pointer for the location of the value in the reference data memory structure is stored as the value for the object attribute.

Using this process, multiple objects point to a same value in the reference data memory structure resulting in deduplication of the value since the value does not need to be stored in both objects. Instead, a same pointer is stored in both objects.

Examples of pointers to the memory locations include memory addresses as well as array indexes or ordinals and hash keys. In general, the benefit of the deduplication is achieved when the pointer has a smaller memory size than the value. When the pointer is substantially smaller than the value and when the value is repeated in many objects, this deduplication results in a significant reduction in the amount of memory required by memory cache 116.

Returning to step 312, if the key selected at step 302 is not part of an object addressed by a primary key, the value is stored in the memory structure created for the key while deduplicating the value at step 322. Thus, the memory structure is examined and if the value was previously stored in the memory structure, the value is not stored again.

After steps 310, 320 and 322, the method of FIG. 3 determines if there are more key-value pairs in the array to process step 324. If there are more keys to process, the process returns to step 302 to select the next key. When all of the keys in the key-value array have been processed at step 324, producer 104 continues the process of FIG. 2 at step 214.

In step 214, producer 104 determines if the time to generate a new data state has arrived. In accordance with one embodiment, producer 104 is programmed to generate a new data state at intermittent times, which can be based on an amount of time that has passed since a last data state was generated or can be based on some other factor such as the number of changes made to memory cache 116 since the last data state was generated, for example. If the time to generate a data state has arrived, data state generator 132 generates a new data state at step 216. In accordance with one embodiment, generating a data state involves making a complete copy of all the memory structures in memory cache 116 to produce a data snapshot 122. Instead of forming a data snapshot 122 each time a new data state is generated, in some embodiments, data deltas 124 are generated that contain the differences between a last data state and the current state of cache 116 where the last data state is represented by the previous data snapshot 122 and zero or more preceding data deltas 124. Eventually, a new data snapshot 122 is formed and all existing data deltas are removed from object store 106.

Once the new data state has been generated, the data snapshot 122 or data delta 124 representing the new data state is stored on object store 106 at step 218. When the data state is stored in object store 106, an announcer module 134 in producer 104 announces the new data state to a watcher 136 in consumer 108 at step 220. When watcher 136 receives such an announcement, consumer pulls the data state from object store 106 using a pull module 138. The pulled data state is then saved in memory cache 118 of consumer 108. In accordance with one embodiment, memory cache 118 is stored in Random Access Memory to provide for fast read access to the data.

In addition to copying the data state to object store 106, data state generator 132 also stores the data state in a state history 135 that can be used to roll back memory cache 116 to a previous state.

After step 220 or if the time to generate a new data state has not arrived at step 214, producer 104 requests the next message from message broker 102 at step 206. Steps 208-220 are then repeated for the newly selected message.

Consumer 108 exposes a number of consumer endpoint APIs 140 and one or more search API endpoints 142 that can be accessed by clients 110, 112 and 114. In accordance with one embodiment, each consumer endpoint API is a restful API that can be accessed using an HTTP protocol. In accordance with one embodiment, each consumer endpoint API 140 represents an object and allows the client to request the attribute values of the object with a GET request. Search API 142 allow the users to request all objects that match a particular value for a particular attribute name provide in a GET request.

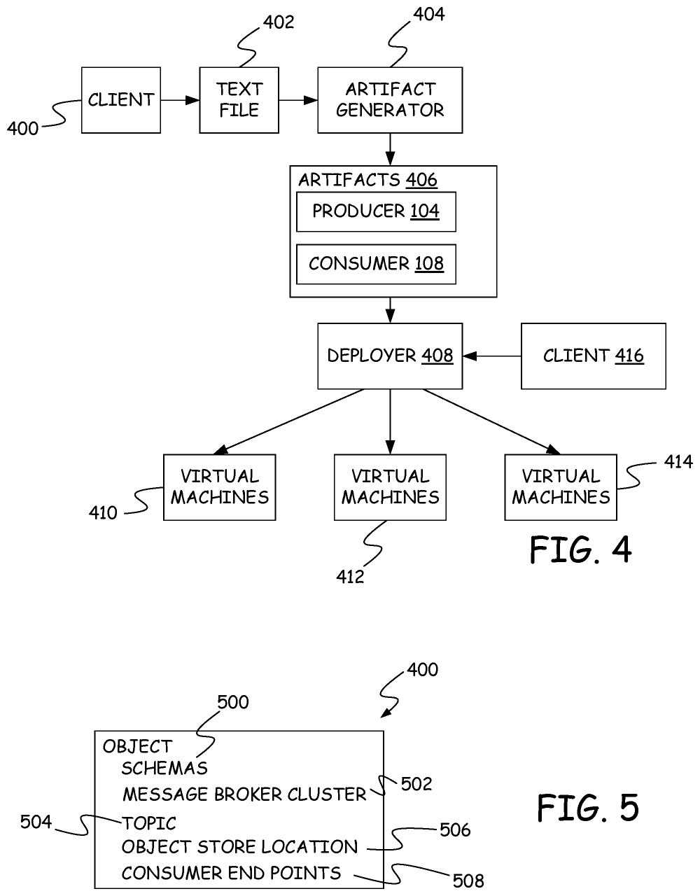

FIG. 4 provides a block diagram of a system for generating and deploying producer 104 and consumer 108. In FIG. 4, client computing device 400 is used to generate a text file 402 containing information needed to generate producer 104 and consumer 108. FIG. 5 provides an example of text file 402 in accordance with one embodiment. As shown in the example of FIG. 5, text file 402 contains object schemas 500 that define the data types found in each object that is to be supported by producer 104 and consumer 108 and that forms object schema 120 in producer 104. Text file 402 also provides a message broker cluster 502 that indicates where message broker 102 resides, and a topic 504 that indicates the particular messages that producer 104 should request from message broker 102. An object store location 506 in text file 402 indicates the server path where object store 106 is to be located. Consumer end points 508 are a collection of consumer API endpoints that consumer 108 needs to support based on object schemas 500.

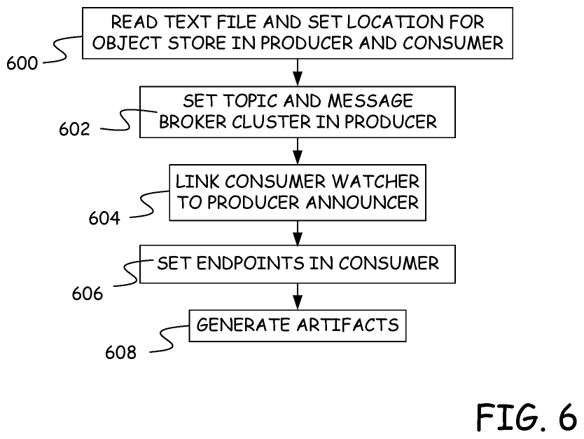

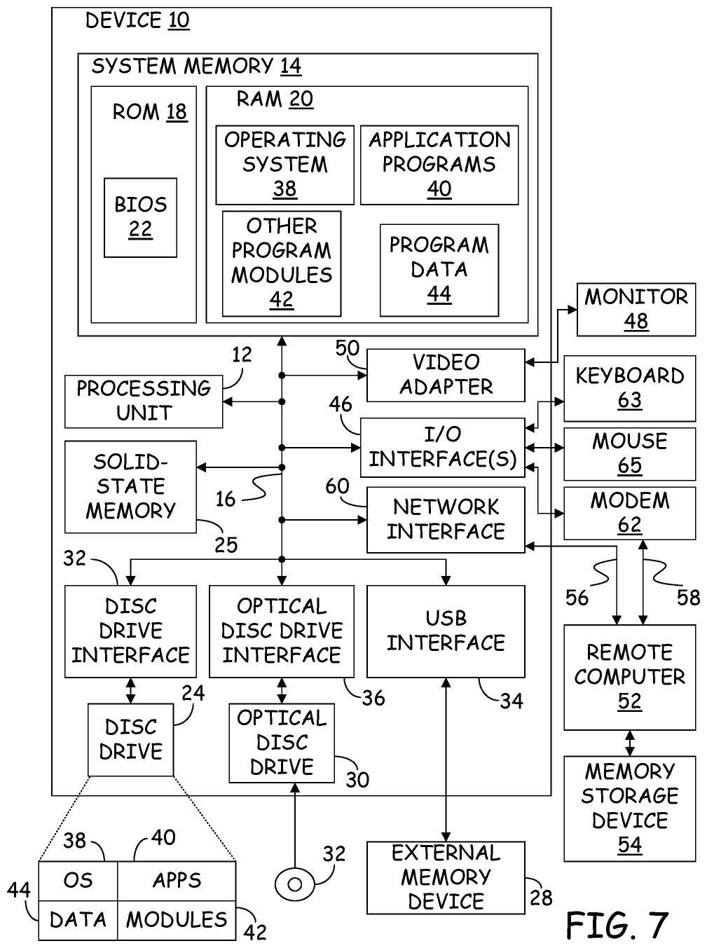

Text file 402 is provided to an artifact generator 404, which uses the information in text file 402 to generate producer 104 and consumer 108 using a method shown in the flow diagram of FIG. 6. In step 600, artifact generator 404 reads text file 402 and sets the location for object store 106 in producer 104 and consumer 108. At step 602, artifact generator 404 reads the topic and the message broker cluster from text file 402 and sets this information in producer 104. At step 604, artifact generator 404 links the watcher in consumer 108 to the announcer in producer 106 so that the watcher receives messages from the announcer. At step 606, artifact generator 404 creates endpoints in consumer 106. In particular, artifact generator 404 creates a separate endpoint for each endpoint listed in text file 402. At step 608, artifact generator 404 compiles producer 104 and consumer 108 as artifacts 406.

Artifact generator 404 typically generates artifacts 406 in a code depository on a computing device. A client device 416 is used to make calls to a deployer 408, that deploys copies of producer 104 and consumer 108 on one or more virtual machines 410, 412, and 414 executing on other devices. Thus, multiple producers can be generating separate copies of the object store from the same message topic to provide data redundancy. In addition, multiple consumers can be running in parallel on different devices to provide access to the object store. For example, a separate consumer can be implemented at each of a plurality of local networks so that devices on each network can make local requests for data thereby reducing latency in obtaining data.

FIG. 7 provides an example of a computing device 10 that can be used to implement one or more of the servers discussed above. Computing device 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of the applications discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 7. The network connections depicted in FIG. 7 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 7 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

1-7. (canceled)

8. A method comprising:
receiving a text file providing a location of a message broker and a location for an object store and containing an object schema that provides definitions for object classes;
using the text file to set the location of the message broker and the location of the object store in the producer software module so that the producer software module is configured to request messages from the message broker, convert the requested messages into objects using the object schema and store the objects at the object store;
using the text file to set the location for the object store in the consumer software module so that the consumer software module is configured to access the object store to retrieve stored objects; and
compiling the producer software module and the consumer software module.

9. The method of claim 8 wherein the consumer software module provides an interface for requesting object attribute values such that when the consumer software module receives a request on the interface, the consumer software module returns the requested object attribute value.

10. The method of claim 8 wherein the text file defines the objects stored in the object store.

11. The method of claim 8 wherein the consumer software module maintains a copy of the object store in a memory cache assigned to the consumer software module.

12. The method of claim 11 wherein compiling the consumer software module comprises compiling the consumer software module on a first device and wherein the compiled consumer software module is configured to be deployed on a second device.

13. The method of claim 11 wherein compiling the consumer software module comprises compiling the consumer software module on a first device and wherein the compiled consumer software module is configured to be deployed on a plurality of other devices.

14. The method of claim 8 wherein the object store comprises a snap shot of a memory cache maintained by the producer software module.

15. The method of claim 14 wherein the object store further comprises changes to the memory cache maintained by the producer software module since the snap shot of the memory cache was produced.

16. A system comprising:
a processor executing a producer module configured:
to request messages from a message broker,
to set values for attributes of objects in a memory cache based on the messages and a schema that provides a definition of object classes, and
to designate states of the memory cache wherein each state comprises all memory structures of the memory cache;
an object store separate from the producer module and the memory cache and containing a state of the memory cache; and
a second processor executing a consumer module configured to request a state of the memory cache from the object store and to maintain the state of the memory cache in a memory cache associated with the consumer module.

17. The system of claim 16 wherein the producer module determines that a value for an attribute of an object is defined as a reference type in the schema and first stores the value in a memory structure created for the reference type then stores a pointer to the value for the object.

18. The system of claim 17 wherein before storing the value in the memory structure created for the reference type, the producer module searches the memory structure created for the reference type to determine if the value is already stored in the memory structure.

19. The system of claim 17 wherein the pointer comprises a hash key and wherein storing the value in the memory location comprises using at least one value in the message to compute the hash key and setting the value for the attribute of the object equal to the hash key.

20. The system of claim 16 wherein setting the value for the attribute of the object comprises identifying at least one key in the message that is designated as a primary key for the object in a schema, using the primary key to determine that the object has not been created yet and in response, creating the object.

21. A method comprising:
a processor executing a producer module configured:
to request messages from a message broker,
to set values for attributes of objects in a memory cache based on the messages and a schema that provides a definition of object classes, and
to designate states of the memory cache, wherein each state comprises all memory structures of the memory cache;
storing a state of the memory cache in an object store separate from the producer module and the memory cache; and
a second processor executing a consumer module configured to request a state of the memory cache from the object store and to maintain the state of the memory cache in a memory cache associated with the consumer module.

22. The method of claim 21 wherein the processor executing the producer module determines that a value for an attribute of an object is defined as a reference type in the schema and first stores the value in a memory structure created for the reference type then stores a pointer to the value for the object.

23. The method of claim 22 wherein before storing the value in the memory structure created for the reference type, the processor executing the producer module searches the memory structure created for the reference type to determine if the value is already stored in the memory structure.

24. The method of claim 22 wherein the pointer comprises a hash key and wherein storing the value in the memory location comprises using at least one value in the message to compute the hash key and setting the value for the attribute of the object equal to the hash key.

25. The method of claim 21 wherein setting the value for the attribute of the object comprises identifying at least one key in the message that is designated as a primary key for the object in a schema, using the primary key to determine that the object has not been created yet and in response, creating the object.

26. The method of claim 21 wherein the second processor executing the consumer software module provides an interface for requesting object attribute values such that when the consumer software module receives a request on the interface, the second processor executing the consumer software module returns the requested object attribute value.
